(19) United States
(12) Patent Application Publication
(10) Pub. No.: US 2018/0220269 A1
(43) Pub. Date: Aug. 2, 2018

(54) METHODS AND APPARATUS FOR SUPPORTING EMERGENCY BROADCAST SERVICES OVER LOCAL AREA NETWORKS

(71) Applicant: QUALCOMM Incorporated, San Diego, CA (US)

(72) Inventors: Rajendra Prasad KATAKAM, Hyderabad (IN); Ashutosh GUPTA, Hyderabad (IN); Ankit BANAUDHA, Hyderabad (IN); Bharadwaj Kumar CHERUVU, Hyderabad (IN); Sreenivasa Rao PERISETLA, Hyderabad (IN); Amandeep Singh BEDI, Hyderabad (IN)

(21) Appl. No.: 15/421,074

(22) Filed: Jan. 31, 2017

(51) Int. Cl. H04W 4/06; H04W 4/22; H04L 29/12

(52) U.S. Cl. CPC H04W 4/06; H04W 84/12; H04L 61/2007; H04W 4/22

(57) ABSTRACT

Various features related to methods and apparatus for supporting broadcast services, e.g., emergency and/or commercial broadcast messages, over LANs, are described. In some configurations broadcast of emergency related messages is offloaded from a cellular network/WWAN to a WLAN, for transmission to devices over the WLAN thereby reducing the overload and/or cost associated with cellular networks and/or extending the emergency broadcast services to users who maybe out of WWAN coverage. Various configurations are described for routing of broadcast messages from the WWAN nodes to a WLAN AP via a WWAN ePDG. The WLAN AP may receive an emergency broadcast message from the ePDG, and broadcast the received emergency broadcast message in a data frame to at least one UE. The emergency broadcast message maybe routed through one or more of a CBC, an MME, an SGW, or a PGW to the ePDG.

### BACKGROUND

### Field

The present disclosure relates generally to communication systems, and more particularly, to methods and apparatus for supporting broadcast services over local area networks.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

Mechanisms for offloading emergency broadcast services from cellular/wireless wide area networks (WWANs) to wireless local area networks are desirable for the purposes of reducing the overload and cost of cellular networks and/or extending the emergency broadcast services to users who may be out of reach of WWAN coverage.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various features related to methods and apparatus for supporting broadcast services, e.g., emergency broadcast information messages and/or commercial broadcast messages, from a WWAN cell broadcast center (CBC), over a local area network (LAN), are described. The LAN may include a wireless LAN (WLAN). In some configurations broadcast of emergency related information such as emergency broadcast messages is offloaded from a cellular WWAN to a WLAN, e.g., interworking WLAN (IWLAN), for transmission to devices connected to the WLAN. Novel mechanisms and configurations are described herein for routing of broadcast service information, e.g., emergency broadcast and/or other commercial broadcast information, from the WWAN nodes to non-cellular, e.g., WLAN, access points via an evolved packet data gateway (ePDG).

In an aspect of the disclosure, a method, a computer-readable medium, and an apparatus are provided. The apparatus, e.g., a WLAN access point (AP), may be configured to receive an emergency broadcast message from a WWAN ePDG, and broadcast the emergency broadcast message received from the WWAN ePDG in a data frame to at least one user equipment (UE).

In another aspect of the disclosure, a method, a computer-readable medium, and an apparatus are provided. The apparatus, e.g., a UE, may be configured to connect to a WLAN through a WLAN AP, and receive a first emergency broadcast message in a data frame from a WWAN ePDG through the WLAN AP. In some embodiments the first emergency broadcast message received through the WLAN AP is one of a Commercial Mobile Alert System (CMAS) message, a Public Warning System (PWS) message, or an Earthquake and Tsunami Warning System (ETWS) message. In some embodiments the first emergency broadcast message is routed through one or more of a WWAN CBC, a WWAN mobility management entity (MME), a WWAN serving gateway (SGW), or a WWAN packet data network (PDN) gateway (PGW) to the WWAN ePDG. In some embodiments the first emergency broadcast message is received through the WLAN AP when a WWAN connection is unavailable or lost. In some embodiments the apparatus may be further configured to receive a second emergency broadcast message from a WWAN base station while connected to the WWAN. In some configurations the apparatus may be further configured to display the first emergency broadcast message received through the WLAN AP, e.g., on a display component of the apparatus. In some embodiments the first emergency broadcast message is a WWAN emergency broadcast message communicating emergency broadcast information from the WWAN CBC.

In yet another aspect of the disclosure, a method, a computer-readable medium, and an apparatus are provided. The apparatus, e.g., a network node, may be configured to receive a broadcast message including emergency indicator information, and send the broadcast message to a WWAN ePDG for transmission to a WLAN when the emergency indicator information indicates the broadcast message is an emergency broadcast message. In some embodiments the broadcast message is one of a CMAS message, a PWS message, an ETWS message or any other emergency or commercial broadcast message. In some embodiments the broadcast message is routed through one or more of a WWAN CBC, a WWAN MME, a WWAN SGW, or a WWAN PGW to the WWAN ePDG.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIG. 4 illustrates a portion of an exemplary communication system and broadcast message information flow via various elements of the communication system.

FIG. 5 illustrates the exemplary communication system of FIG. 4 in greater detail with additional elements not shown in FIG. 4, in accordance with an exemplary embodiment.

FIG. 6 illustrates an exemplary routing of an exemplary broadcast message, e.g., including emergency and/or commercial broadcast information, through various elements of the exemplary communication system of FIG. 5, in accordance with an exemplary embodiment.

FIG. 7 is a flowchart of an exemplary method of wireless communication of a WLAN AP in accordance with an exemplary embodiment

FIG. 8 is a conceptual data flow diagram illustrating the data flow between different means/components in an exemplary apparatus.

FIG. 9 is a diagram illustrating an example of a hardware implementation for an apparatus employing a processing system.

FIG. 10 is a flowchart of an exemplary method of wireless communication of a UE in accordance with an exemplary embodiment.

FIG. 11 is a conceptual data flow diagram illustrating the data flow between different means/components in an exemplary UE.

FIG. 12 is a diagram illustrating an example of a hardware implementation for a UE employing a processing system.

FIG. 13 is a flowchart of an exemplary communication method of a network node in accordance with an exemplary embodiment.

FIG. 14 is a conceptual data flow diagram illustrating the data flow between different means/components in an exemplary network node.

FIG. 15 is a diagram illustrating an example of a hardware implementation for a network node employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

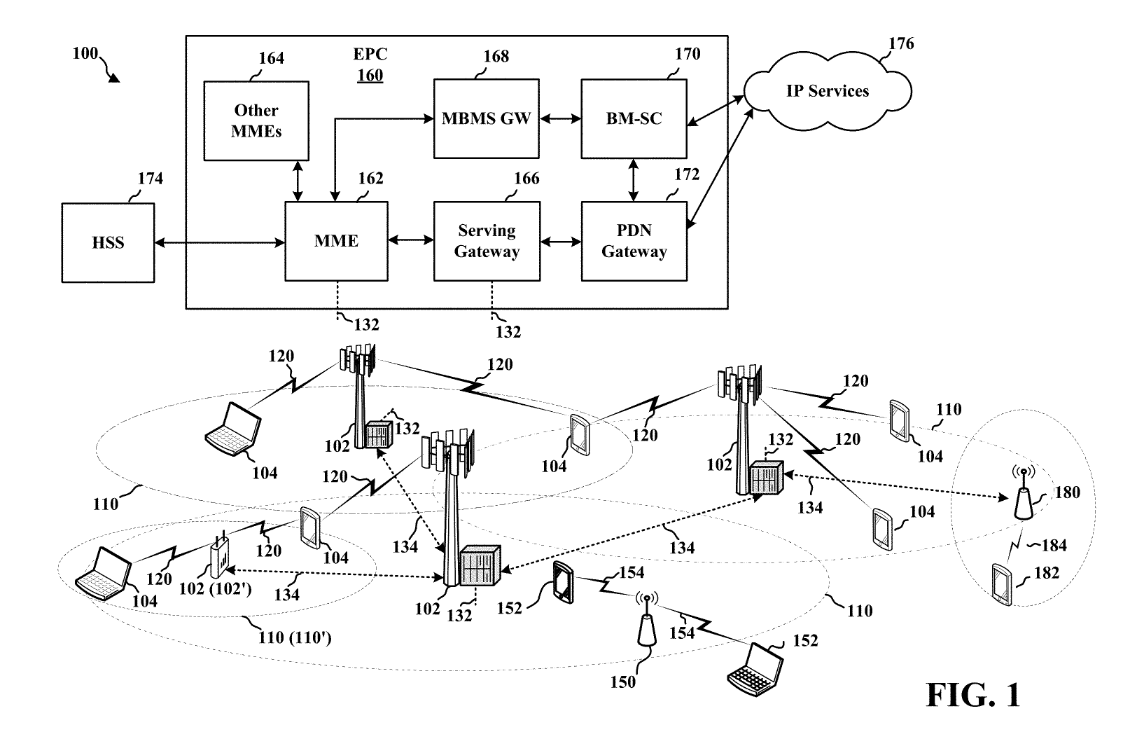

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The millimeter wave (mmW) base station 180 may operate in mmW frequencies and/or near mmW frequencies in communication with the UE 182. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 182 to compensate for the extremely high path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

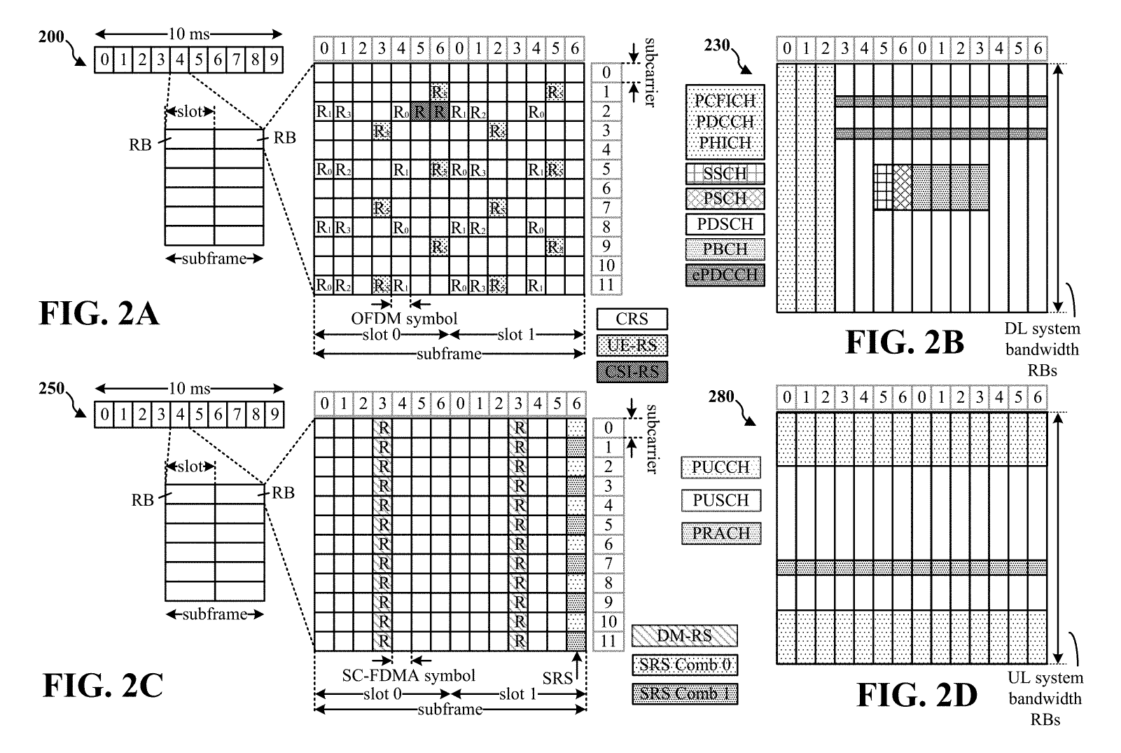

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

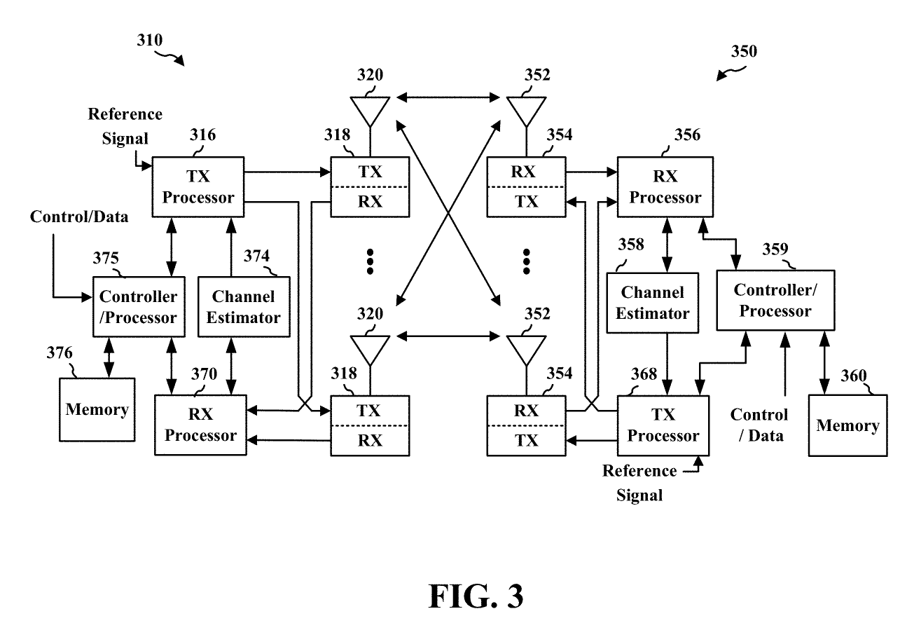

FIG. 3 is a block diagram of an eNB 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the eNB 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

Currently some services provided over the cellular/3GPP networks can be offloaded to WiFi networks to reduce the overload and cost of 3GPP networks. Many of the IP Multimedia Subsystem (IMS) and 3GPP services like voice over LTE (VoLTE), Video-Telephony (VT), rich communication services (RCS), short message services (SMS), Enhanced 911 (E911) may be provided over wireless local area networks (e.g., WiFi) using an ePDG. WLAN coverage, e.g., over WiFi, may also be available in areas where normal WWAN/cellular (e.g., UMTS/LTE) coverage is not available e.g. underground parking, underground subway and/or train station, sewers etc. Also, a person can carry a small battery powered WiFi dongle device anywhere where normal cellular WWAN coverage is not available. In the case of an emergency, in no coverage area a CMAS message and/or a PWS message and/or an ETWS message and/or other emergency service related message may need to be distributed to device users to notify the users of emergency conditions and/or available emergency relief services. Thus methods and apparatus for providing emergency broadcast services like the CMAS message service, PWS message service, ETWS information related service over non cellular networks, e.g., over WLANs, are needed and highly desirable. Various features related to supporting emergency broadcast services using ePDG-IWLAN are described below.

Whenever there is no cellular/WWAN (e.g., LTE/UMTS) coverage, currently a UE may get many of the 3GPP services over IWLAN. However unfortunately many broadcast services including vital emergency broadcast services are not currently offered over WLANs, e.g., over a WiFi network. If broadcast services like CMAS, PWS, and ETWS are not offloaded to WiFi and/or other local wireless networks, in indoor and/or underground scenarios where there is no cellular WWAN coverage, the emergency related warning messages may not reach the users in such areas which is highly undesirable. Thus the desirability and need of methods and apparatus to support offloading 3GPP broadcast services to IWLANs is evident.

Various features related to implementing broadcast services e.g., CMAS, PWS, ETWS, and/or other commercial or emergency broadcast services over WiFi using ePDG-IWLAN path based on S2b interface are described. Currently many broadcast/multicast services use beacons over WiFi. An IP packet (e.g., including emergency broadcast information) with broadcast IP from an ePDG may be used by a WLAN access point (AP) to broadcast, e.g., over WiFi, to all users accessing the WLAN through the WLAN AP. When the UE's connected to ePDG (e.g., UEs that are associated with the ePDG and/or authorized to receive WWAN services) receive the broadcast IP packet using broadcast IP configured based on an ePDG assigned IP address, the UE's consider the packet for processing to recover the communicated broadcast information. Other devices which are not affiliated with the WWAN service provider and/or not getting 3GPP services using the ePDG, just simply discard the packet as the broadcast IP (e.g., configured by the ePDG) used to broadcast the IP packet is unknown to these devices and thus such devices are unable to decode the packet as it is security protected.

In some configurations if information, e.g., emergency related messages, are intended to be broadcast to non-3GPP users/subscribers in addition to 3GPP users, then such information may be broadcast without being IP secured by the ePDG and/or using a broadcast IP address of the WLAN AP broadcasting the information to the connected devices rather than the broadcast IP assigned by the ePDG.

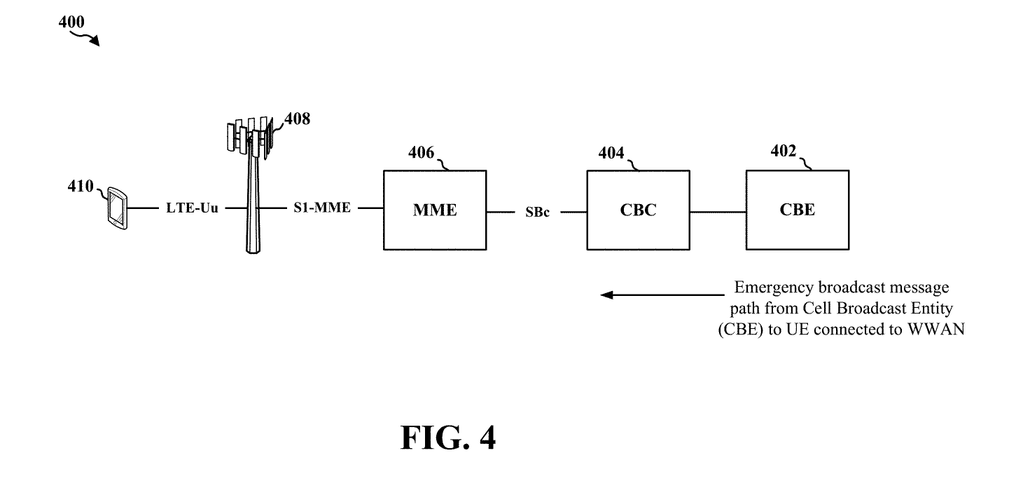

FIG. 4 is a drawing illustrating broadcast information flow via various elements of an exemplary communication system 400, e.g., a WWAN, to a UE having a connection to the WWAN. The portion of the communication system 400 shown in FIG. 4 includes a CBC 404 (also referred to as WWAN CBC), an MME 406 (also referred to as WWAN MME), a base station/eNB 408, and a UE 410. The MME 406 may be the MME 162 or among the other MMES 164 of FIG. 1, the base station 408 may be one of the base stations 102 and the UE 410 may be one of the UEs 104 of FIG. 1. The CBC 404 receives the emergency and/or warning information messages from a cell broadcast entity (CBE) 402 which may be based with government or a trusted authority. The CBC 404 may map the target area to the network cells and send the broadcast messages to the MME 406 which may manage the message broadcast to the end user devices. In the communication system 400, the MME 406 receives broadcast messages (e.g., including emergency broadcast information) from the CBC 404 and sends the broadcast messages to one or more base station, e.g., eNBs, using S1-Application Protocol (AP) messages over streaming control transport protocol/internet protocol (SCTP/IP) interface as illustrated in FIG. 4. For example, the MME 406 may send the broadcast message over the S1 interface (S1-MME signaling interface that supports SCTP/IP) to the base station 408. The base station 408 may then broadcast the messages to end user devices such as UE 410.

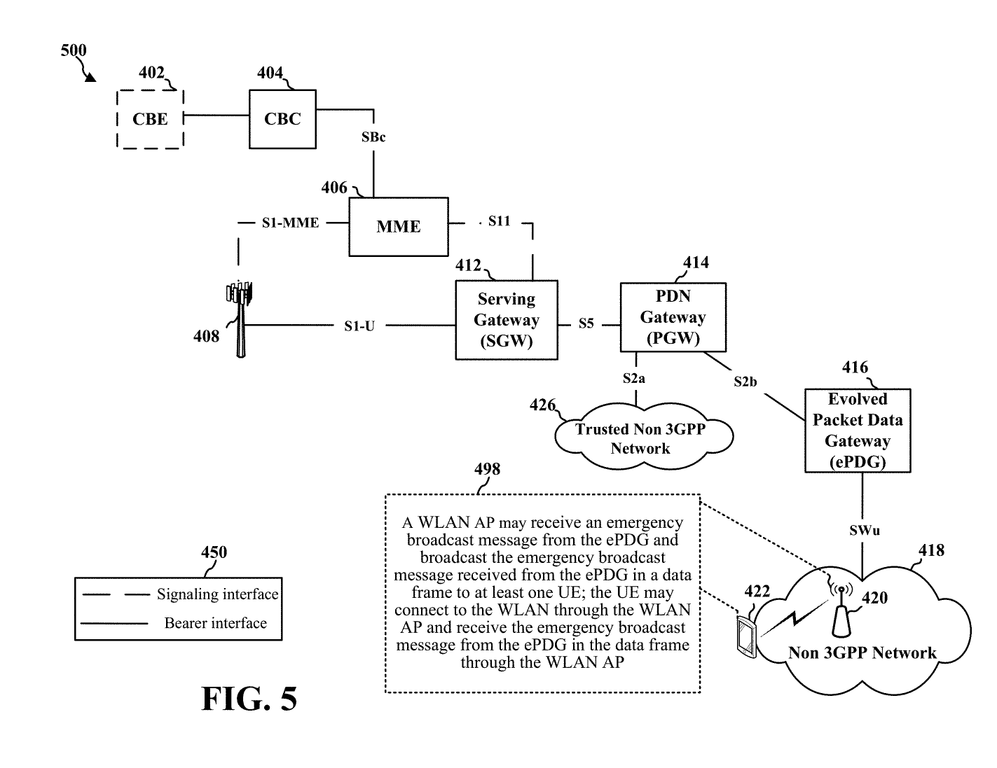

In order to get the broadcast services offloaded over to IWLAN, the broadcast messages need to be communicated from the MME 406 to an ePDG (not shown in FIG. 4) via which the broadcast messages may be delivered to user devices which may not subscribe to cellular/WWAN service and/or are out of WWAN coverage. To route such broadcast messages (including commercial and/or emergency broadcast information) to an ePDG which has a link to external non cellular network, e.g., a local area network such as a WLAN, the broadcast messages need to be optimized for various interfaces via which the broadcast messages are routed from the MME 406 to the ePDG as discussed with regard to FIG. 5.

FIG. 5 is a drawing 500 illustrating the exemplary communication system 400 in greater detail with additional elements not shown in FIG. 4 example. The communications system 400 may be a part of the system and access network of FIG. 1 and includes many elements which may be the same or similar to the elements discussed above with regard to FIG. 1. In addition to the elements already discussed above with regard to FIG. 4, the additional elements of communications system 400 shown in FIG. 5 include a SGW 412 (also referred to as WWAN SGW), a PGW 414 (also referred to as WWAN PGW), and an ePDG 416 (also referred to as WWAN ePDG) which has a link to external non cellular network 418, e.g., a local area network such as a WLAN or a wired LAN. The network 418 may be an untrusted non cellular network, e.g., from the perspective of the WWAN network (e.g., the communication system 400). The ePDG 416 is responsible for interworking between the core WWAN network and untrusted non-3GPP networks (shown as the network 418) that require secure access, e.g., such as a WiFi network, LTE metro network, and femtocell access networks etc. The ePDG 416 may use Internet Protocol Security (IPsec)/Internet Key Exchange v2 (IKEv2) or proxy mobile IPv6 (e.g., when a UE is in an untrusted non-3GPP network) for secure access to the WWAN/cellular network. Thus the ePDG 416 may be used to provide connectivity (e.g., for cellular/WWAN network services) between the elements of the communication system 400 (e.g., core network elements) and UEs in the non-cellular network 418.

The non-cellular (e.g., non 3GPP) network 418 may include one or more access points (APs) such as WLAN AP 420 which may serve as a wireless access point for one or more UEs such as UE 422. While the WLAN AP 420 is used in the exemplary system 400, it should be appreciated that the network 418 may be a wired local network in some configurations and include APs providing network connectivity to UEs over a wired local network, e.g., Ethernet. The PGW 414 may have a link to a trusted non cellular network 426. The SGW 412 may be the same or similar to the serving gateway 166 and the PGW 414 may be the same or similar to the PDN gateway 172 of FIG. 1. The base station 408 connects to the MME 406 via the S1-MME interface and to the SGW by means of the S1-U interface. The S1 interface supports a many-to-many relation between MMEs/serving gateways and base stations/eNBs. Legend 450 shows the line patterns used in FIG. 5 to represent signaling and bearer interfaces.

As discussed above, the MME 406 receives the broadcast messages, e.g., emergency broadcast messages, from the CBC 404. In accordance with one aspect of some embodiments, to route such a broadcast message to the ePDG 416 the MME 406 optimizes/customizes the broadcast message for various interfaces over which the broadcast message is communicated S11, S5, and S2b interfaces. In some embodiments such optimization involves including an extra emergency indicator bit to the broadcast message to allow proper routing of the broadcast message. The emergency indicator bit may indicate to a receiving network node, e.g., a gateway such as the SGW 412 that receives the customized broadcast message from the MME 406, that the broadcast message is an emergency broadcast message and should be forwarded to one or more ePDGs 416. Thus upon receiving such an optimized broadcast message from the MME 406, the receiving node, e.g., SGW 412 determines an appropriate forwarding route for the broadcast message to communicate the broadcast message to the ePDG 416. Thus in one aspect, to offload the WWAN network, rather than forwarding the broadcast message from the MME 406 to the network base station (e.g., eNB) 408, the broadcast message is sent to the ePDG 416, which in turn communicates the broadcast message to the WLAN AP 420, which broadcasts the emergency broadcast information in a data frame (e.g., WiFi data frame or another appropriate data frame depending on the local area network over which the broadcast is intended) to user devices, e.g., UE 422, connected to non-cellular networks, e.g., WLANs.

Referring again to FIG. 5, in certain aspects the WLAN AP 420 may be configured (498) to receive a broadcast message (e.g., an emergency broadcast message) from the ePDG 416 and broadcast the emergency broadcast message received from the ePDG 416 in a data frame to at least one UE (e.g., UE 422). The UE 422 may be configured (498) to connect to the WLAN 418 through the WLAN AP 420 and receive a first emergency broadcast message from the ePDG 416 through the WLAN AP 420 in a data frame. While the UE 422 receives the first emergency broadcast message in a data frame, e.g., a WiFi data frame if the WLAN AP is a WiFi access point, the actual emergency broadcast message communicated in the data frame is a WWAN broadcast message from the CBC 404.

While the above discussion describes communicating the broadcast information from the WWAN to the WLAN AP 420 which may be in a non-trusted network, it should appreciated that the methods and techniques can also be used for communicating the broadcast information to APs in trusted networks as well. In such configurations the broadcast information from the CBC 404 may be routed through the same WWAN elements as discussed above with the exception of the ePDG 416. Thus the broadcast information may be routed from the PGW 414 to a WLAN AP in a trusted network such as network 426 without being routed through the ePDG 416.

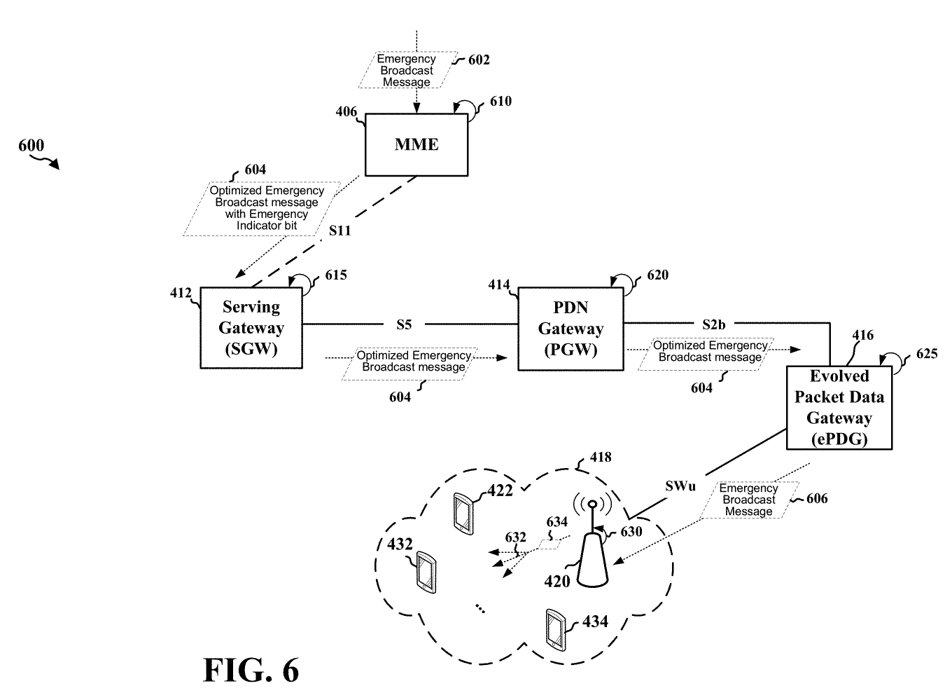

FIG. 6 is a drawing 600 illustrating exemplary routing of an exemplary broadcast message, e.g., including emergency and/or commercial broadcast information, in accordance with an exemplary embodiment. As discussed above with regard to FIG. 5, a broadcast message from the CBC 404 is optimized by the MME 406 and can be routed through the SGW 412 and the PGW 414 (over appropriate interfaces) to the ePDG 416. From the ePDG 416 the broadcast message may be communicated to one or more non 3GPP networks, e.g., IWLAN or other networks, for distribution to devices connected to such networks.

In the exemplary message routing shown in drawing 600 of FIG. 6, in accordance with one aspect the MME 406 having received a broadcast message 602 (from CBC 404) determines (curved arrow 610) that the broadcast message 602 includes emergency broadcast information and is to be sent to the ePDG 416. The MME 406 generates an optimized broadcast message 604 with emergency indicator information that can be forwarded over the S11, S5, and S2b interfaces. The MME 406 then sends the optimized broadcast message 604 over the S11 interface to the SGW 412. The emergency indicator information indicates to a receiving node, e.g., SGW 412, that the broadcast message 604 includes, e.g., emergency broadcast information, and is to be forwarded to one or more ePDGs of the WWAN communication system 400. Thus the optimized broadcast message 604 with the extra indicator bit allows the receiving network nodes to determine the appropriate route for forwarding the optimized broadcast message 604. It should be appreciated that while the optimized broadcast message 604 includes the emergency indicator information (e.g., an emergency indicator bit) for appropriate routing of the broadcast message to the ePDG 416 over the S11, S5, and S2b interfaces, the actual content, e.g., payload, of the broadcast message 604 is the broadcast information received by the MME 406 in the broadcast message 602.

The SGW 412 upon receiving and processing the optimized broadcast message 604 determines (curved arrow 615) that the received message is an emergency broadcast to be sent to the ePDG 416 and thus forwards the broadcast message 604 over the S5 interface to the PGW 414. Similarly the PGW 414 upon receiving and processing the optimized broadcast message 604 determines (curved arrow 620) that the received message is an emergency broadcast to be sent to the ePDG 416 and thus forwards the broadcast message 604 to the ePDG 416 over the S2b interface.

The ePDG 416 receives the optimized broadcast message 604. Upon processing the received broadcast message the ePDG determines (curved arrow 625) that the received message includes broadcast information for user devices in the non 3GPP network 418. The ePDG 416 further determines whether the broadcast message (and/or broadcast information received in the message) is to be broadcast to all UEs in the network 418 connected to the WLAN AP 420 or only to WWAN service subscribers, e.g., UEs corresponding to authorized/registered service subscribers. Such determination may be based on previous network configuration and/or specific signaling from the network 400 (e.g., control signaling from a network node such as the MME 406) conveying to the ePDG 416 whether the broadcast message 604 (actual broadcast information payload of the message) of the received broadcast message 604 is intended for broadcasting to all UEs or only to WWAN service subscribers in the network 418. In the case when the ePDG 416 determines that the broadcast message 604 is intended to be broadcast only to the registered WWAN service subscribers (e.g., 3GPP services subscribers), in such a case the ePDG 416 may generate a broadcast message 606 by adding the broadcast IP address of the ePDG 416 to the broadcast message 604 and sends the broadcast message 606 to the WLAN AP 420. Such an encapsulation, e.g., addition of the broadcast IP address of the ePDG 416, adds a layer of security to the message being broadcast since only authentic WWAN service subscribers will be able to decode the message being broadcast using the broadcast IP address of the ePDG 416. The WLAN AP 420 receives the message 606 and determines (curved arrow 630) whether to use the ePDG 416 assigned broadcast IP address as the destination address or use the WLAN AP's broadcast IP address as the destination address for the broadcast (represented by arrows 632) to UEs 422, 432, . . . , 434, e.g., based on format of the received broadcast message 606, preconfigured information and/or other specific signaling. In the above case, following the determination the WLAN AP 420 broadcasts (632) the information (e.g., payload of the received message 606) in a data frame 634 using the broadcast IP address of the ePDG 416. In this case while the UEs 422, 432, . . . , 434 may receive the broadcast (632), only the one or more UEs that are WWAN service subscribers are able to decode the broadcast message while other non WWAN subscriber UEs may discard the received broadcast since as they are unable to decode the broadcast message which has been broadcast using the ePDG assigned broadcast IP address.

On the other hand if the ePDG 416 determines that the broadcast message 604 is intended to be broadcast to all UEs connected to the WLAN AP 420, the ePDG 416 may generate the broadcast message 606 based on the broadcast message 604, e.g., with the broadcast message 606 still including the actual payload communicated by broadcast message 602/604 but without adding the broadcast IP address of the ePDG 416 and send the broadcast message 606 to the WLAN AP 420. In this case the WLAN AP 420 receives the broadcast message 606 and broadcasts (632) the broadcast message 606 in a data frame 634 using the broadcast IP address of the WLAN AP 420. In this case the UEs 422, 432, . . . , 434 which are connected to the WLAN AP 420 receive the broadcast of the data frame 634 including the broadcast message 606 are able to decode the broadcast message 606. While in the above discussion it has been described that the data frame 634 includes the broadcast message 606, in some configurations what may be included in the data frame 634 is the actual broadcast information communicated in the broadcast message 606 (e.g., payload of the broadcast message 606) which is the same information communicated in the broadcast message 602 from the CBC 404. However in some configurations the data frame 634 may include the entire broadcast message 606.

In some configurations even though the message 606 received by the WLAN AP 420 from the ePDG 416 may be encapsulated in a manner to include the broadcast IP of the ePDG 416, however the WLAN AP 420 may be configured to broadcast the message to UEs 422, 432, . . . , 434 using the both the broadcast IP of the ePDG 416 as well as using its own broadcast IP address (e.g., in separate broadcasts) thereby allowing non WWAN service subscribers to get the emergency broadcast. While FIGS. 5-6 examples refer to emergency broadcast messages, it should be appreciated that the broadcast information being sent from the MME 406 to the ePDG 416 for broadcast to UEs 422, 432, . . . , 434 may relate to non-emergency and/or commercial broadcast as well. The UEs 422, 432, . . . , 434 may be within or out of WWAN coverage.

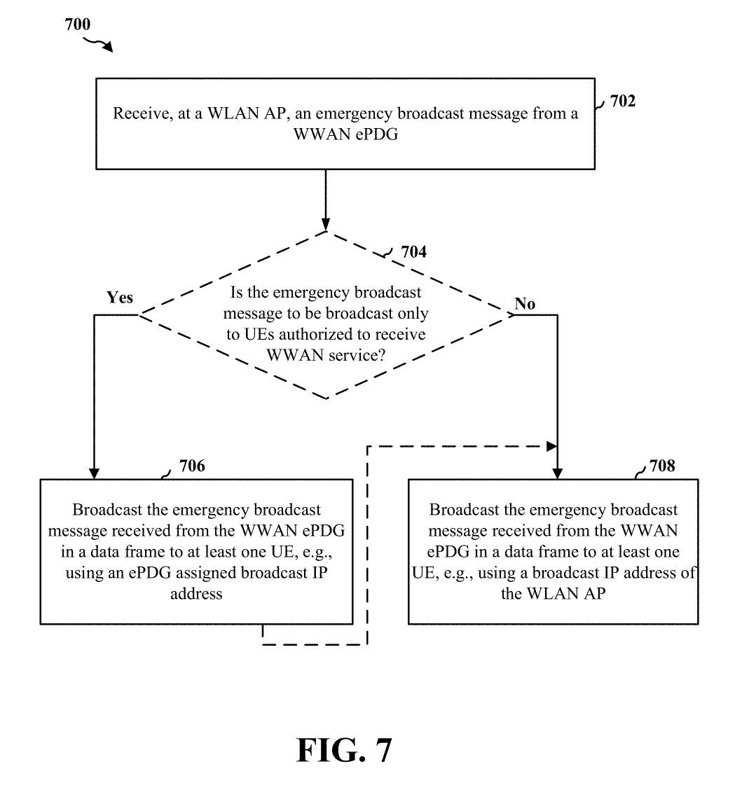

FIG. 7 is a flowchart 700 of an exemplary method of wireless communication of a WLAN AP in accordance with an aspect. The method may be performed by e.g., WLAN AP 420 of system 400. While the exemplary method of flowchart 700 is described with regard to a WLAN AP it should be appreciated that methods and techniques described herein are applicable to access points which may provide network access to connected devices over a wired network as well. Some of the operations may be optional as represented by dashed/broken lines. At 702, the WLAN AP 420 may receive an emergency broadcast message from a WWAN ePDG, e.g., ePDG 416. For example with reference to FIGS. 5 and 6, the WLAN AP 420 may receive the broadcast message 606 including emergency broadcast information from the ePDG 416 as discussed in detail above. In some configurations, the received emergency broadcast message is one of a CMAS message, a PWS message, or an ETWS message. In some embodiments the ePDG 416 is part of the WWAN communication system 400 and is thus sometimes also referred to as a WWAN ePDG. Thus in some embodiments, the emergency broadcast message is received from a 3GPP network (e.g., communication system 400). In some embodiments, while the emergency broadcast message is received from a 3GPP network, the WLAN AP 420 receiving the emergency broadcast message from the WWAN ePDG 416 is associated with a non-3GPP network, e.g., network 418. In some such embodiments, the WLAN AP 420 is associated with an untrusted non-3GPP network. For example, with reference to FIGS. 5 and 6, in some configurations the network 418 may be untrusted non-3GPP network. As discussed with regard to FIGS. 5 and 6, in some embodiments the emergency broadcast message (the broadcast information-payload) is routed through one or more of the WWAN CBC 404, the WWAN MME 406, the WWAN SGW 412, or the WWAN PGW 414 to the WWAN ePDG 416. While the above discussion refers to the routing of the broadcast message, it should be appreciated that at one or more points in the message route, the message format may change as appropriate, however in some embodiments the payload of the original broadcast message (e.g., the broadcast information in the broadcast message 602 from CBC 404) remains the same, and it is the broadcast information that is routed through the WWAN CBC 404, WWAN MME 406, a WWAN SGW 412, or a WWAN PGW 414 to the WWAN ePDG 416 even if included in different messages during the routing.

At 704 the WLAN AP 420 determines whether the emergency broadcast message is to be broadcast to all connected UE's or only UE's authorized to receive WWAN services, e.g., WWAN service subscriber. In some embodiments, such determination may be based on preconfigured information on the WLAN AP or configuration information and/or specific signaling from the network 400 received via the ePDG 416 (e.g., control signaling from a network node such as the MME 406) conveying whether the broadcast message 604 (actual broadcast information payload of the message) of the received broadcast message 604 is intended for broadcasting to all UEs or only to WWAN service subscribers in the network 418. For example, as discussed above with regard to FIG. 6, the WLAN AP 420 may determine (630) whether to use the ePDG 416 assigned broadcast IP address as the destination address (when the message is to be broadcast to all connected UE's) or use the WLAN AP's broadcast IP address as the destination address for the broadcast (when the message is to be broadcast only to WWAN service subscribers).

When at 704 the determination is that the emergency broadcast message is to be broadcast only to the WWAN service subscriber devices, then the operation proceeds to 706 where the WLAN AP 420 broadcasts the emergency broadcast message received from the WWAN ePDG in a data frame to at least one UE, e.g., a UE authorized to receive WWAN services, using a broadcast IP address of the ePDG 416 (or assigned/configured by the ePDG 416). Thus in some configurations, the data frame including the emergency broadcast message is broadcast by the WLAN AP 420 using a broadcast IP address assigned by the ePDG 416. Such a broadcast message transmitted using the ePDG assigned broadcast IP address may only be recovered by WWAN service subscriber devices but not by other devices which may receive the broadcast message from the WLAN AP 420 but discard the received message. On the other hand if at 704 it is determined that the emergency broadcast message is to be broadcast to all UEs connected to the WLAN AP, then the operation proceeds to 708 where the WLAN AP 420 broadcasts the emergency broadcast message received from the ePDG 416 in a data frame to at least one UE using a broadcast IP address of the WLAN AP 420.

In some embodiments, the WLAN AP 420 may be configured to broadcast the emergency broadcast message received from the ePDG 416 using both (e.g., in separate data frames) the ePDG assigned broadcast IP address and the WLAN AP broadcast IP address as indicated in the flowchart 700 by the broken line arrow from 706 to 708.

In some embodiments, the WLAN AP 420 is a WiFi AP and the data frame being broadcast is a WiFi data frame. Various other types of WLAN APs are possible, e.g., Bluetooth AP which may provide the emergency broadcast to connected devices via Bluetooth, or another device which may operate as an AP providing the emergency broadcast to connected devices via a wired (e.g., Ethernet) connection. Accordingly, various corresponding different types of data frames are possible for communicating the broadcast information from the WLAN AP 420 to the UEs 422, 432, . . . , 434.

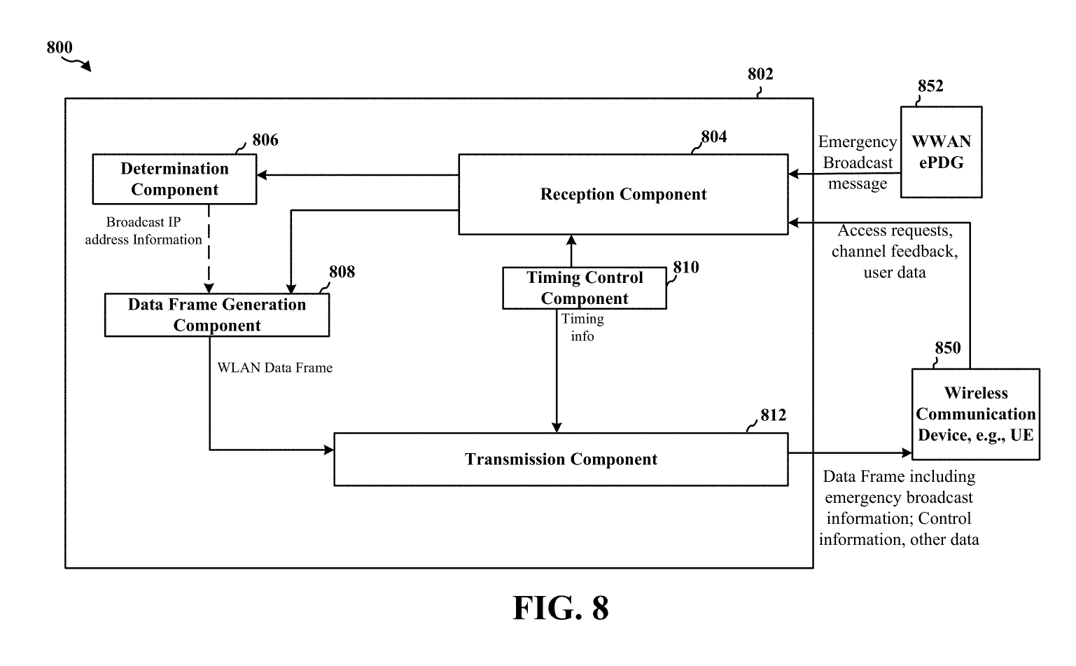

FIG. 8 is a conceptual data flow diagram 800 illustrating the data flow between different means/components in an exemplary apparatus 802. The apparatus 802 may be an access point, e.g., a WLAN AP 420. The apparatus 802 may include a reception component 804, a determination component 806, a data frame generation component 808, a timing control component 810 and a transmission component 812.

The reception component 804 may be configured to receive and process signals and/or information from other devices. For example, the received signals and/or information may include access/connection requests, user data and/or other messages from one or more UEs and messages from WWAN nodes. The reception component 804 may be configured to receive an emergency broadcast message from a WWAN ePDG 852. The WWAN ePDG 852 may the ePDG 416 of FIG. 6. For example, referring to FIG. 6 the emergency broadcast message may be the message 606 received from the ePDG 416. The received emergency broadcast message from a WWAN ePDG 852 is a WWAN emergency broadcast message, e.g., an emergency message from a cellular network/WWAN.

The determination component 806 may be configured to determine whether the emergency broadcast message is intended to be broadcast to all UE's connected to the apparatus 802 or only UE's authorized to receive WWAN services. The determination component 806 may be further configured to determine if a data frame (generated by component 808) including the WWAN emergency broadcast message is to be broadcast using an ePDG assigned broadcast IP address as the destination address or use the broadcast IP address of the apparatus 802 (WLAN AP) as the destination address for the broadcast (when the message is intended to only go to WWAN service subscribers). In some embodiments the determination component 806 may be configured to make such determination based on the received emergency broadcast message format, e.g., based whether the broadcast IP address of the ePDG 852 has been added to the received broadcast message from the ePDG 852, and/or based on preconfigured information and/or signaling from the ePDG 852. In some configurations the determination component 806 may provide information to the data frame generation component 808 to include the appropriate broadcast IP address as the destination address of the generated data frame including the emergency broadcast message (information).

The data frame generation component 808 may be configured to generate a data frame including the emergency broadcast information from the received emergency broadcast message from the ePDG 852. Depending on a given configuration/implementation of the apparatus, the data frame generated by component 808 may be WiFi data frame or another data frame compliant with the a given communication protocol used by the apparatus 802 to provide access to connected devices, e.g., UEs 422, 432, . . . , 434. The data frame may be generated by the data frame generation component 808 using the received emergency broadcast message, e.g., by encapsulating the received broadcast message and/or by including the actual payload of the emergency broadcast message in the generated data frame as the payload of the data frame, where the payload of the received emergency broadcast message includes the emergency broadcast information data. In some configurations the data frame generation component 808 may be further configured to include the broadcast IP address assigned by the ePDG 852 or the broadcast IP address of the apparatus 802 as the destination address of the generated data frame communicating the emergency broadcast to one or more UEs, e.g., UE 850. The UE 850 maybe, e.g., any one of the UEs 422, 432, . . . , 434.

The timing control component 810 may be configured to provide transmission/reception timing information to the transmission and reception components 802 and 804, respectively, to control transmission and reception of data and/or control information. The transmission component 812 may be configured to broadcast the emergency broadcast message received from the WWAN ePDG in the data frame (generated by component 808) to at least one UE. In some embodiments the transmission component 812 may be configured to broadcast the data frame including the emergency broadcast message using a broadcast IP address assigned by the ePDG 852. In some embodiments the transmission component 812 may be configured to broadcast the data frame including the emergency broadcast message using a broadcast IP address of the apparatus 802.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

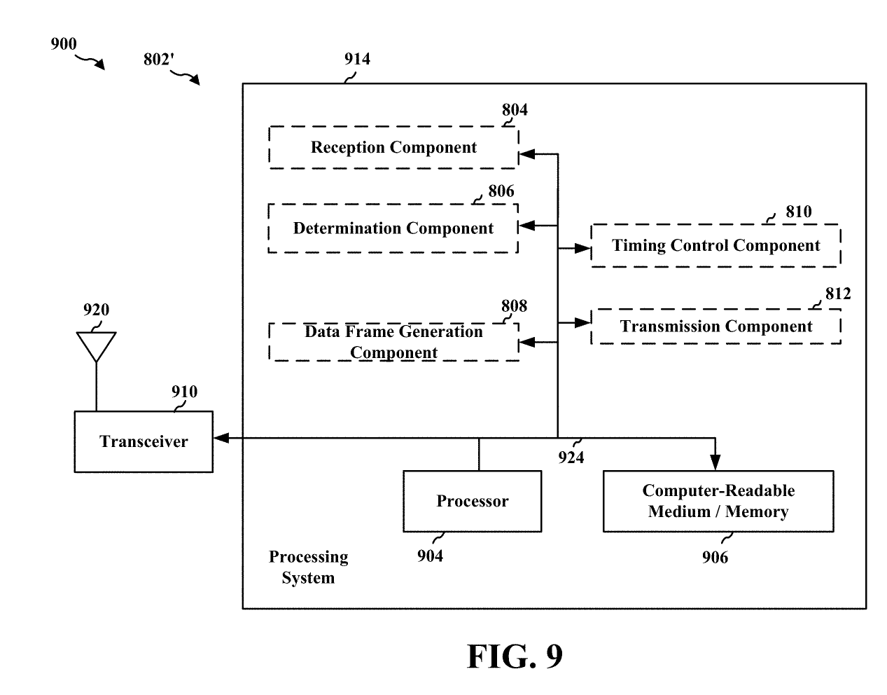

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 may include individual transmitter and receiver circuits in some embodiments. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 812, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810 and 812. The components may be software components running in the processor 904, resident/stored in the computer-readable medium/memory 906, one or more hardware components coupled to the processor 904, or some combination thereof.

In one configuration, the apparatus 802/802′ for wireless communication includes means for receiving an emergency broadcast message from a WWAN ePDG, and means for broadcasting the emergency broadcast message received from the WWAN ePDG in a data frame to at least one UE. In some configurations, the apparatus 802/802′ further includes means for determining whether the emergency broadcast message is to be broadcast to all UE's connected to the apparatus 802/802′ or only the WWAN service subscriber UE's. In some configurations, the apparatus 802/802′ further includes means for generating the data frame including the emergency broadcast message. The aforementioned means may be one or more of the aforementioned components of the apparatus 802 and/or the processing system 914 of the apparatus 802′ configured to perform the functions recited by the aforementioned means. In some embodiments the processing system 914 may include a TX processor (e.g., similar to TX processor 316), the RX processor (e.g., similar to RX processor 370), and a controller (e.g., similar to controller/processor 375). As such, in one configuration, the aforementioned means may be such TX processor, RX processor, and the controller/processor configured to perform the functions recited by the aforementioned means.

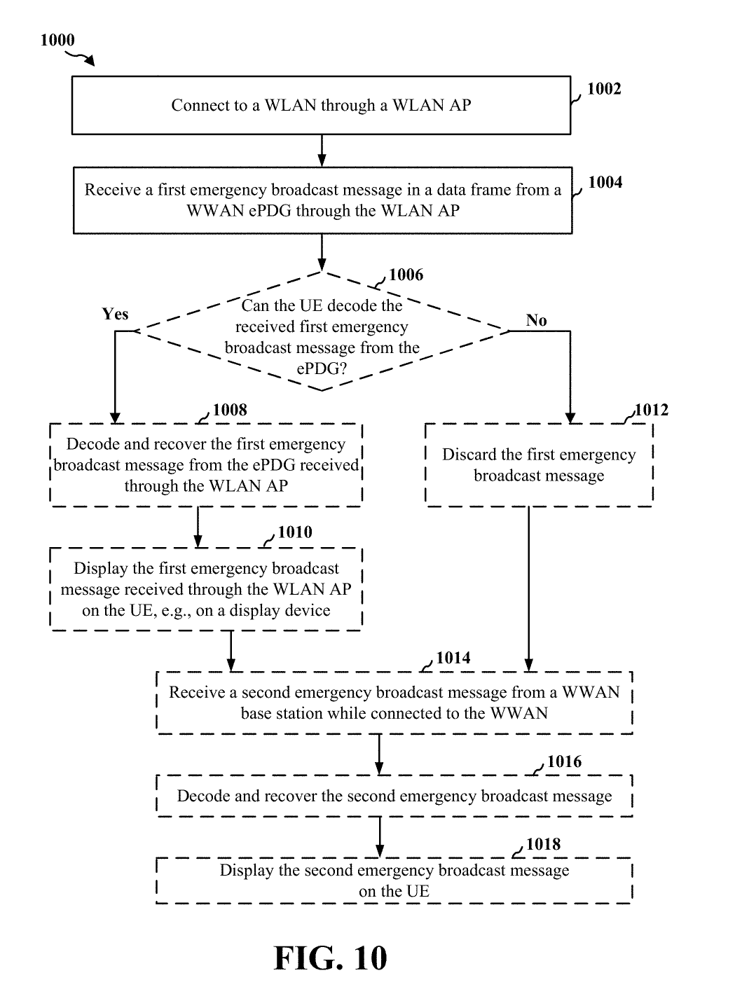

FIG. 10 is a flowchart 1000 of an exemplary method of wireless communication of a UE in accordance with one embodiment. The method may be performed by any one of the UEs 422, 432, . . . 434. Some of the operations may be optional as represented by dashed/broken lines and/or boxes shown with broken lines. At 1002, the UE may connect to an access point in a local area network (LAN). In some configurations the local network may be a WLAN and the access point may be a wireless AP such as WLAN AP 420. At 1004 the UE may receive a first emergency broadcast message in a data frame from a WWAN evolved packet data gateway (ePDG) through the WLAN AP. For example with reference to FIG. 6, the UE 422 may receive the broadcast (632) of a data frame including the first emergency broadcast message from the ePDG 416 through the WLAN AP 420. The first emergency broadcast message received through the WLAN AP may be one of a CMAS message, PWS message, or an ETWS message. The first emergency broadcast message in some configurations is routed through one or more of a WWAN CBC, a WWAN MME, a WWAN SGW, or a WWAN PGW to the WWAN ePDG. In some embodiments the first emergency broadcast message is received through the WLAN AP when a WWAN connection is unavailable to the UE or lost. In various embodiments the first emergency broadcast message is a WWAN emergency broadcast message communicating emergency broadcast information from the WWAN CBC 404. While the message format and/or encapsulation of the message (carrying the emergency broadcast information from the WWAN CBC) may change during the message routing, the actual emergency broadcast information remains unchanged in some embodiments.

At 1006 the UE may determine if the first emergency broadcast message information received in the data frame is decodable by the UE. In accordance with one aspect, whether the UE can decode a received emergency broadcast message from the ePDG may depend on whether the emergency broadcast message is received i) using a broadcast IP address configured based on an ePDG assigned IP address or ii) using a broadcast IP address of the WLAN AP through which the emergency broadcast is received by the UE, and based on whether the UE itself is associated (e.g., registered) with the WWAN. Thus in some embodiments the determination at 1006 may include determining/checking whether the emergency broadcast message is received using the broadcast IP address configured based on an ePDG assigned IP address or using the broadcast IP address of the WLAN AP. As previously discussed, the UEs that are associated with the WWAN with which the ePDG is associated, may be considered associated or connected to the ePDG. Such UEs which are WWAN service subscribers are able to process and decode the first emergency broadcast message received using an ePDG assigned broadcast IP address while other UEs discard the message. If the first emergency message is received using the broadcast IP address of the WLAN AP through which the emergency broadcast is received, then all UEs connected to the WLAN AP may decode and recover the emergency broadcast even if the UE is not associated with the WWAN/3GPP network. Thus in such configurations even the non 3GPP users may receive the emergency broadcast if desired.

Depending on the determination at 1006, the operation proceeds to either 1008 or 1012 in some embodiments. If at 1006 the UE determines that the first emergency message can be decoded by the UE the operation proceeds to 1008. At 1008 the UE may decode and recover the first emergency broadcast message from the ePDG received through the WLAN AP. Next at 1010 the UE displays the first emergency broadcast message (e.g., information content) on the UE, e.g., on a display device/component of the UE. While block 1010 describes displaying the broadcast message as a way of outputting the message, it should be appreciated that many other ways of outputting the first emergency broadcast message are possible, e.g., via a speaker as an audio alert and/or alarm tone, or as a vibration alert on the UE alone or in combination with an audio and/or video output of the first emergency broadcast message. In some configurations the operation proceeds from 1010 to 1014 as discussed below.

On the other hand if at 1006 the UE determines that the first emergency message cannot be decoded, then at 1012 the UE, being unable to process the first emergency broadcast message, discards the first emergency broadcast message. In some configurations the operation proceeds from 1012 to 1014 as discussed below.

At 1014 the UE may receive a second emergency broadcast message from a WWAN base station while (when) connected to the WWAN. For example, in cases where the UE is within the coverage of the WWAN (with which the UE is associated) and where the emergency broadcast messaging service has not been offloaded to local networks or partially offloaded, the UE may receive the emergency broadcast from a WWAN base station to which the UE is connected. For example, referring to FIG. 5, the UE 422 may be associated with the WWAN communication system 400 and may receive the second emergency broadcast message from the base station 408. At 1016 the UE may decode and recover the received second emergency broadcast message. Finally at 1018 the UE may output, e.g., display, the received second emergency broadcast message.

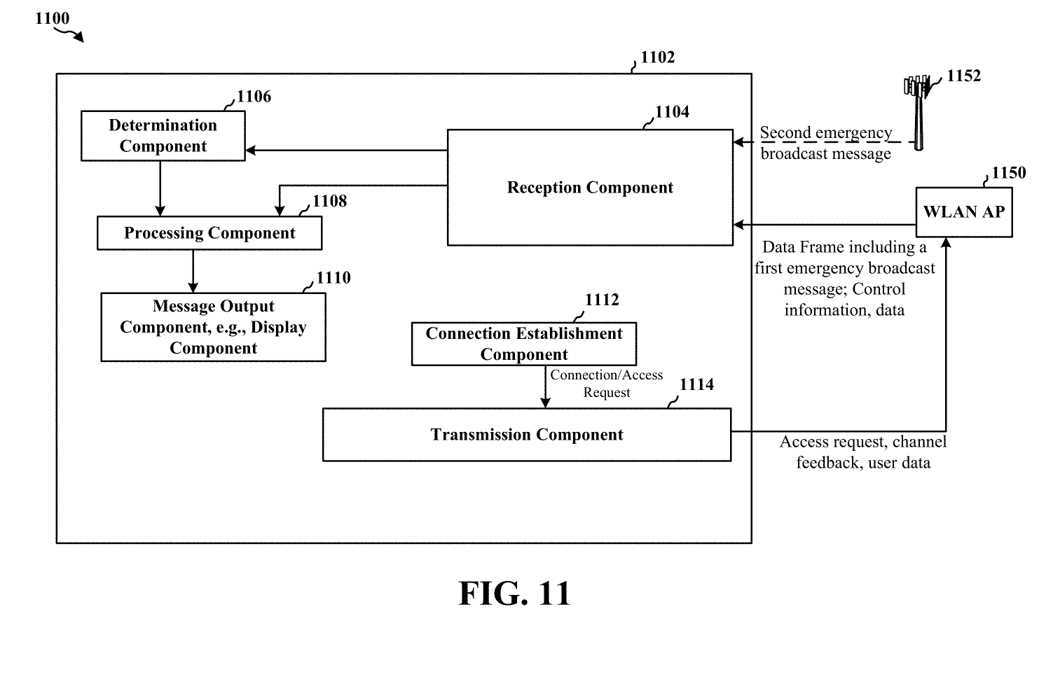

FIG. 11 is a conceptual data flow diagram 1100 illustrating the data flow between different means/components in an exemplary apparatus 1102. The apparatus may be a UE, e.g., such as the UE 422. The apparatus 1102 may include a reception component 1104, a determination component 1106, a processing component 1108, a message output component 1110, a connection establishment component 1012 and a transmission component 1014.

The reception component 1104 may be configured to receive and process messages and/or information from other devices such as WWAN base stations, WLAN access points and/or other UEs. For example, the reception component 1104 may be configured to receive a first emergency broadcast message in a data frame from a WWAN ePDG through the WLAN AP 1150. The WLAN AP 1150 may be the WLAN AP 420 of FIG. 5. The reception component 1104 may be further configured to receive a second emergency broadcast message from the WWAN base station 1152 when the UE/apparatus 1102 is connected to the WWAN, e.g., WWAN communication system 400. The WWAN base station 1152 may be the base station/eNB 408 of FIG. 5. In some embodiments, the reception component 1104 may include a first receiver interface/circuit (e.g., a WiFi, Bluetooth or such receiver) configured to receive the data frame including the first emergency broadcast message, and a second receiver interface/circuit (e.g., a WWAN receiver) configured to receive the second emergency broadcast message.

The determination component 1106 may be configured to determine if the first emergency broadcast message information received in the data frame is decodable by the apparatus 1102, e.g., based on the criteria discussed above with regard to the previous figures. In some configurations, the determination component 1106 may be further configured to pass the received first emergency broadcast message to the processing component 1108 when it is determined that the first emergency broadcast message can be decoded by the apparatus 1102. In some configurations, the determination component 1106 may be further configured to discard the received first emergency broadcast message when it is determined that the first emergency broadcast message cannot be decoded by the apparatus 1102.

The processing component 1108 may be configured to process the received data frame to decode and recover the first emergency broadcast message from the ePDG received through the WLAN AP 1150. The processing component 1108 may be further configured to provide the decoded first emergency broadcast message to the message output component 1110 for output, e.g., display. The processing component 1108 in some embodiments may be configured to decode and recover the received second emergency broadcast message from the WWAN base station 1152. The message output component 1110 may be, e.g., a display device and/or another output device via which the received emergency broadcast message may be output. In some configurations, the message output component 1110 may be configured to display the received emergency broadcast message (e.g., the first and/or second emergency broadcast message).

The connection establishment component 1112 may be configured to control the apparatus 1102 to connect to a WLAN through the WLAN AP 1150, e.g., through which the first emergency broadcast message is received. The transmission component 1114 may be configured to generate and transmit messages and/or information to other devices such as WWAN base stations, WLAN access points and/or other UEs.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

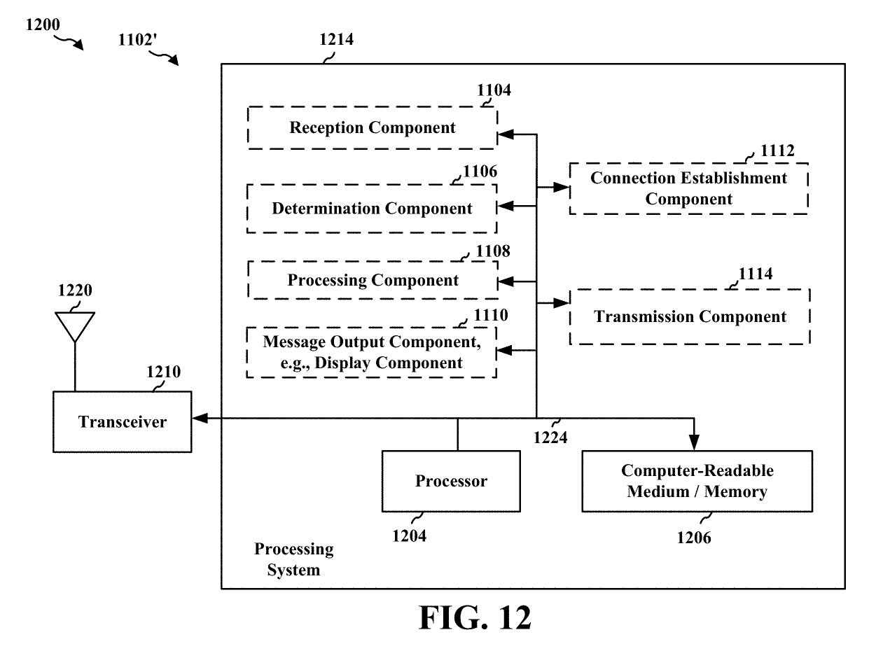

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, 1114, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1114, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112 and 1114. The components may be software components running in the processor 1204, resident/stored in the computer-readable medium/memory 1206, one or more hardware components coupled to the processor 1204, or some combination thereof. The processing system 1214 may be a component of the UE 350 and may include the memory 360 and/or at least one of the TX processor 368, the RX processor 356, and the controller/processor 359.

In one configuration, the apparatus 1102/1102′ for wireless communication includes means for connecting to a local area network, e.g., a WLAN, through a WLAN AP, and means for receiving a first emergency broadcast message in a data frame from a WWAN ePDG through the WLAN AP. In some embodiments the means for receiving is configured to receive the first emergency broadcast message through the WLAN AP when a WWAN connection is unavailable or lost. In some embodiments the means for receiving is further configured to receive a second emergency broadcast message from a WWAN base station while connected to the WWAN. In some configurations, the apparatus 1102/1102′ further includes means for processing, decoding and recovering received an emergency broadcast message, e.g., the first and/or second emergency broadcast message. In some configurations, the apparatus 1102/1102′ further includes means for displaying the first emergency broadcast message received through the WLAN AP on the UE. The means for displaying may be further configured to display the second emergency broadcast message.

The aforementioned means may be one or more of the aforementioned components of the apparatus 1102 and/or the processing system 1214 of the apparatus 1102′ configured to perform the functions recited by the aforementioned means. As described supra, the processing system 1214 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

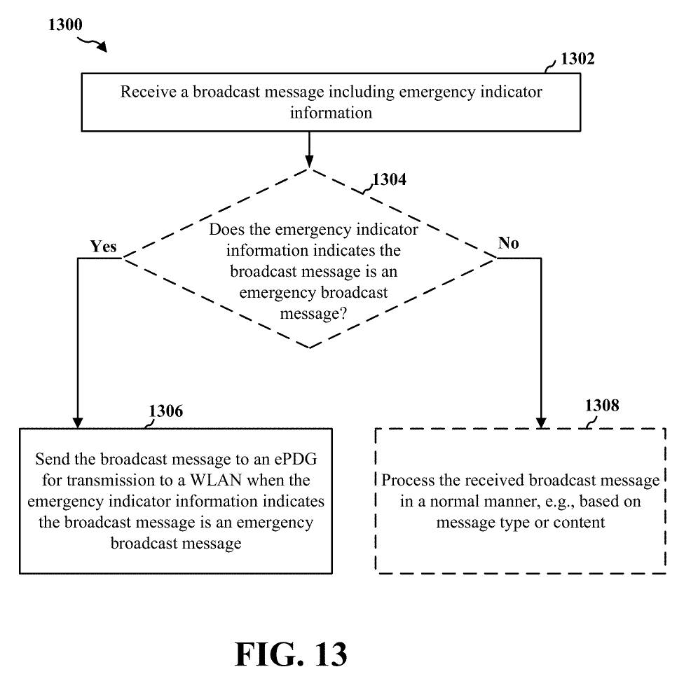

FIG. 13 is a flowchart 1300 of an exemplary method of communication of an exemplary network node of a WWAN, in accordance with an aspect. The method may be performed by e.g., the SGW 412 or the PGW 414 of the WWAN communication system 400. Some of the operations may be optional as represented by dashed/broken lines. At 1302 the network node receives a broadcast message including emergency indicator information. In some embodiments the broadcast message includes emergency and/or commercial broadcast information. In some embodiments the broadcast message is an emergency broadcast message such as a CMAS, PWS and/or ETWS message. In some embodiments the network node receives the broadcast message from another node, e.g., MME 406. In some embodiments the MME 406 may receive broadcast information from a WWAN CBC, e.g., CBC 404, and generate the broadcast message by including the broadcast information and adding the emergency indicator information. For example, referring to FIG. 6 the message may be the broadcast message 604. In some embodiments the emergency indicator information is included in a specific bit of the broadcast message which is sometimes referred to as emergency indicator bit. In some such embodiments a type of the broadcast message may be indicated by the sending node, e.g., MME 406, to a receiving node (e.g., SGW 412, PGW 414, ePDG 416) that receives the broadcast message with the emergency indicator bit by setting the bit “0” or “1”. For example, in some configurations setting the emergency indicator bit to “1” indicates that the broadcast message carries a particular type of broadcast, e.g. an emergency information broadcast and/or commercial information broadcast, and indicates a destination of the broadcast message. In one embodiment setting the emergency indicator bit to “1” indicates that the broadcast message carries an emergency information broadcast and indicates that the message should be forwarded to one or more ePDGs associated with a WWAN. In some configurations when the emergency indicator bit is set to “0” and/or the emergency indicator information is not included in a received broadcast message, this may indicate to the network node that the broadcast message does not relate to emergency broadcast and may be handled in a normal manner, e.g., based on the information and/or content of the message, message format or other normal handling procedure used by the network node to process such messages. For the purposes of discussion consider that the broadcast message received by the network node at 1302 includes emergency indicator information.

At 1304 the network node may determine whether the emergency indicator information indicates that the broadcast message is an emergency broadcast message, e.g., based on the set value of the indicator bit. When the emergency indicator information indicates that the broadcast message is an emergency broadcast message then at 1306 the network node may send the broadcast message to an ePDG for transmission on a WLAN, e.g., with the broadcast message being sent to the ePDG for sending to an AP of the WLAN for broadcast on the WLAN. For example, referring to FIGS. 5 and 6, the SGW 412 upon determining that the broadcast message 604 is an emergency broadcast message forwards the broadcast message 604 to the PGW 414 which forwards it to the ePDG 416. Thus in various embodiments the broadcast message is routed through one or more of a WWAN CBC, a WWAN MME, a WWAN SGW, or a WWAN PGW to the WWAN ePDG. The ePDG 416, that has a link to the WLAN 418, is configured to send the broadcast message to the WLAN 418, e.g., to the WLAN AP 420, over SW interface (an interface to the non-3GPP network 418). As discussed supra, the WLAN AP 420 broadcasts the emergency broadcast information over the WLAN, e.g., WiFi, to one or more connected UEs. When the emergency indicator information indicates that the broadcast message is not an emergency broadcast message (e.g., indicator bit set to “0”) then at 1308 the network node may process, handle and/or forward the received broadcast message in a normal manner, e.g., based on the information and/or content of the message, message format and/or type.

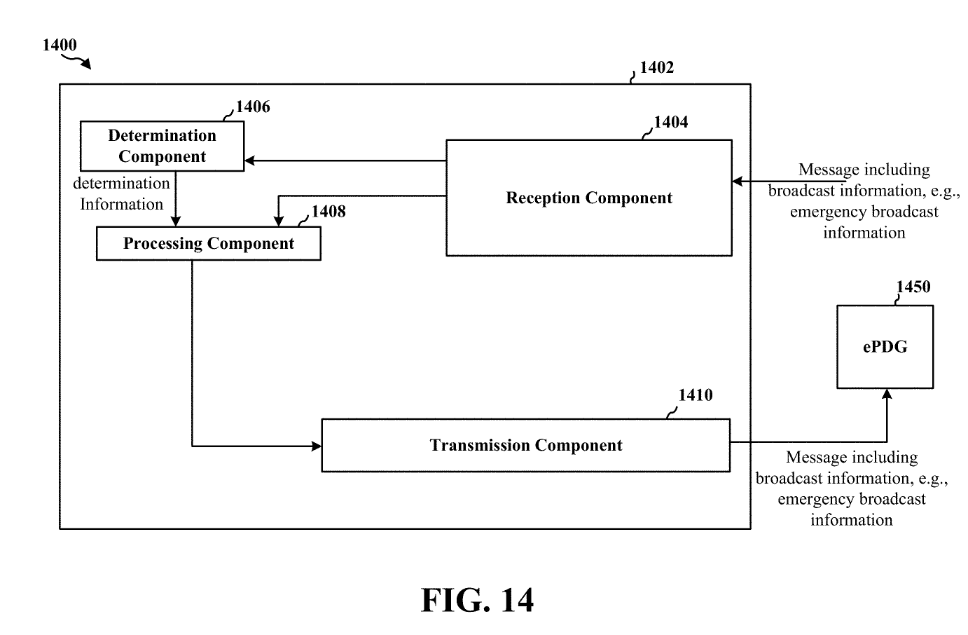

FIG. 14 is a conceptual data flow diagram 1400 illustrating the data flow between different means/components in an exemplary apparatus 1402. The apparatus 1402 may be a network node of a WWAN such as the SGW 412 or PGW 414. While the SGW 412 or PGW 414 may be implemented as the exemplary apparatus 1402 of FIG. 14, various other nodes such as the MME 406 and/or ePDG 416 may be implemented in a similar manner with similar means/components and/or interfaces as described with regard to the apparatus 1402. The apparatus 1402 may include a reception component 1404, a determination component 1406, a processing component 14014 and a transmission component 1410.

The reception component 1404 may be configured to receive and process messages and/or information from other devices. For example in some configurations the reception component 1404 may be configured to receive a broadcast message including emergency indicator information. In some configurations the reception component 1404 may be included as part of a network interface of the apparatus 1402. In some embodiments the broadcast message includes emergency and/or commercial broadcast information. In some embodiments the apparatus 1402 receives the broadcast message from another node, e.g., MME 406. For example, referring to FIG. 6 the reception component may be configured to receive the broadcast message 604.

The determination component 1406 may be configured to determine whether the emergency indicator information indicates that the broadcast message is an emergency broadcast message, e.g., based on the set value of the emergency indicator bit as discussed above in detail with regard to FIG. 13. The determination component 1406 may be further configured to provide determined information to the processing component 1408 based on the determination. The processing component 1408 may be configured to process and/or forward the received broadcast message, e.g., based on whether or not the emergency indicator information indicates that the broadcast message is an emergency broadcast message. The processing component 1408 may use the determined information from component 1406 to appropriately process and/or handle the received broadcast message.

The transmission component 1410 may be configured to send the broadcast message to a WWAN ePDG, e.g., WWAN ePDG 1450, for transmission to a WLAN when the emergency indicator information indicates the broadcast message is an emergency broadcast message. The WWAN ePDG 1450 may be the ePDG 416 of FIG. 6. When the apparatus 1402 is implemented as the SGW 412 the transmission component 1410 may send the broadcast message to the ePDG 416, e.g. by forwarding the broadcast message through the PGW 414 to the ePDG 416. When the apparatus 1402 is implemented as the PGW 414 the broadcast message may be sent directly to the ePDG 416.

The apparatus may include additional components that perform each of the blocks of the algorithm in the aforementioned flowchart of FIG. 13. As such, each block in the aforementioned flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

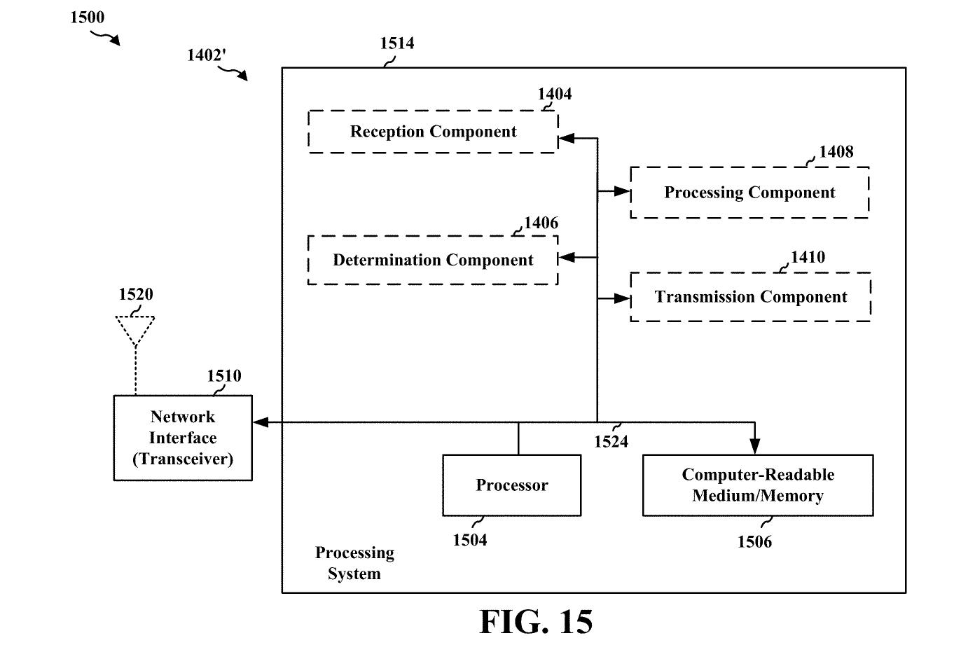

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a network interface 1510. The network interface may be a wired interface including a transceiver, however an optional wireless transceiver may be included as well in some configurations. 1510 Via the network interface 1510 couples the apparatus The network interface 1510 may include individual transmitter and receiver circuits in some embodiments. In some embodiments where the network interface includes the optional wireless transceiver, the wireless transceiver is coupled to one or more antennas 1520. The network interface 1510 provides a means for communicating with various other apparatus over a transmission medium. The transceiver of the network interface 1510 may receive a signal (e.g., over wired or wireless medium), extracts information from the received signal, and provides the extracted information to the processing system 1514, specifically the reception component 1404. In addition, the transceiver of the network interface 1510 receives information from the processing system 1514, specifically the transmission component 1410, and based on the received information, generates a signal to be transmitted (e.g., over a wired medium and/or via the one or more antennas 1520). The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1408 and 1410. The components may be software components running in the processor 1504, resident/stored in the computer-readable medium/memory 1506, one or more hardware components coupled to the processor 1504, or some combination thereof.

In one configuration, the apparatus 1402/1402′ for communication includes means for receiving a broadcast message including emergency indicator information, and means for sending the broadcast message to a WWAN ePDG for transmission to a WLAN when the emergency indicator information indicates the broadcast message is an emergency broadcast message. In some configurations, the apparatus 1402/1402′ further includes means for determining whether the emergency indicator information indicates that the broadcast message is an emergency broadcast message In some configurations, the apparatus 1402/1402′ further includes means for processing the received broadcast message based on a determination about the emergency indicator information in the broadcast message. The aforementioned means may be one or more of the aforementioned components of the apparatus 1402 and/or the processing system 1514 of the apparatus 1402′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a wireless local area network (WLAN) access point (AP), comprising:
receiving an emergency broadcast message from a wireless wide area network (WWAN) evolved packet data gateway (ePDG); and
broadcasting the emergency broadcast message received from the WWAN ePDG in a data frame to at least one user equipment (UE).

2. The method of claim 1, wherein the emergency broadcast message is one of a Commercial Mobile Alert System (CMAS) message, a Public Warning System (PWS) message, or an Earthquake and Tsunami Warning System (ETWS) message.

3. The method of claim 1, wherein the emergency broadcast message is routed through one or more of a WWAN cell broadcast center (CBC), a WWAN mobility management entity (MME), a WWAN serving gateway (SGW), or a WWAN packet data network (PDN) gateway (PGW) to the WWAN ePDG.

4. The method of claim 1, wherein the emergency broadcast message is received from a 3GPP network.

5. The method of claim 1, wherein the data frame including the emergency broadcast message is broadcast using a broadcast IP address assigned by the WWAN ePDG.

6. The method of claim 5, wherein the broadcast IP address assigned by the WWAN ePDG secures the emergency broadcast message to be decoded by devices associated with a communication network with which said WWAN ePDG is associated.

7. The method of claim 1, wherein the data frame including the emergency broadcast message is broadcast using a broadcast IP address of the WLAN AP.

8. The method of claim 7, wherein the broadcast IP address of the WLAN AP enables one or more devices connected to the WLAN AP to decode the emergency broadcast message.

9. The method of claim 1, wherein the emergency broadcast message is a WWAN emergency broadcast message communicating emergency broadcast information from a WWAN cell broadcast center (CBC).

10. An apparatus for wireless communication, comprising:
means for receiving an emergency broadcast message from a wireless wide area network (WWAN) evolved packet data gateway (ePDG); and
means for broadcasting the emergency broadcast message received from the WWAN ePDG in a data frame to at least one user equipment (UE).

11. The apparatus of claim 10, wherein the emergency broadcast message is one of a Commercial Mobile Alert System (CMAS) message, a Public Warning System (PWS) message, or an Earthquake and Tsunami Warning System (ETWS) message.

12. The apparatus of claim 10, wherein the emergency broadcast message is routed through one or more of a WWAN cell broadcast center (CBC), a WWAN mobility management entity (MME), a WWAN serving gateway (SGW), or a WWAN packet data network (PDN) gateway (PGW) to the WWAN ePDG.

13. The apparatus of claim 10, wherein the means for broadcasting is configured to broadcast the data frame including the emergency broadcast message using a broadcast IP address assigned by the WWAN ePDG.

14. The apparatus of claim 13, wherein the broadcast IP address assigned by the WWAN ePDG secures the emergency broadcast message to be decoded by devices associated with a communication network with which said WWAN ePDG is associated.

15. The apparatus of claim 10, wherein the means for broadcasting is configured to broadcast the data frame including the emergency broadcast message using a broadcast IP address of the WLAN AP.

16. The apparatus of claim 15, wherein the broadcast IP address of the WLAN AP enables one or more devices connected to the WLAN AP to decode the emergency broadcast message.

17. An apparatus for wireless communication, comprising:
a memory; and
at least one processor coupled to the memory and configured to:
receive an emergency broadcast message from a wireless wide area network (WWAN) evolved packet data gateway (ePDG); and
broadcast the emergency broadcast message received from the WWAN ePDG in a data frame to at least one user equipment (UE).

18. The apparatus of claim 17, wherein the at least one processor is further configured to broadcast the data frame including the emergency broadcast message using a broadcast IP address assigned by the WWAN ePDG.

19. The apparatus of claim 18, wherein the broadcast IP address assigned by the WWAN ePDG secures the emergency broadcast message to be decoded by devices associated with a communication network with which said WWAN ePDG is associated.

20. The apparatus of claim 17, wherein the at least one processor is further configured to broadcast the data frame including the emergency broadcast message using a broadcast IP address of the WLAN AP.
